(19) United States
(12) Patent Application Publication
(10) Pub. No.: US 2022/0250702 A1
(43) Pub. Date: Aug. 11, 2022

(54) FRONT FAIRING FOR A SCOOTER

(71) Applicant: Zapp Electric Vehicles Limited, London (GB)

(72) Inventors: Swin Chatsuwan, London (GB); Warin Thanathawee, London (GB); Namkarn Munprasit, London (GB)

(73) Assignee: Zapp Electric Vehicles Limited, London (GB)

(21) Appl. No.: 17/732,625

(22) Filed: Apr. 29, 2022

Related U.S. Application Data
(63) Continuation of application No. PCT/IB2019/059346, filed on Oct. 31, 2019.

(51) Int. Cl. B62J 17/02; B62K 19/48

(52) U.S. Cl. CPC B62J 17/02; B62K 19/48

(57) ABSTRACT

A front fairing for a scooter that includes a front fork assembly including a triple tree and forks includes: a fairing body that partially defines a shape of the front fairing and that includes a frontward surface, and a rearward surface connected to the front fork assembly; a first connecting member disposed on the rearward surface and that provides temporary connection to the triple tree such that the front fairing is detachable from the triple tree; and two or more of second connecting members on the rearward surface each of which provides temporary connection to one of the forks such that the front fairing is detachable from the forks. The first connecting member and the second connecting members are integral with the fairing body within a same mold. The rearward surface engages with a rear fairing member.

### TECHNICAL FIELD

The present invention relates to a front fairing for a scooter.

### BACKGROUND

It is known in the arts that scooters are usually provided with a frame assembly at the front of the scooter to provide protection to the scooter from environmental factors, as well as to reduce wind resistance while operating. Particularly, conventional scooters are provided with a frontal frame structure called front fairings and/or simply called fairings.

Generally, front fairings are a part of a scooter's overall body fairings and fixed to the frame of the vehicle. With such configuration, they tend to have various disadvantages, for example, there might be difficulties in the installation of the fairings on the scooter during both assembly and disassembly, as well as difficulties in maintenance of both fairings and other related components, such as the windshield and headlights, since the fairings are formed as substantial pieces covering a significant area of the vehicle. In addition, the cost of maintenance for the vehicle can potentially increase as damage to any part of the body fairing might lead to a necessary replacement of the entire body fairing.

U.S. Pat. No. 4,010,976 discloses a motorcycle fairing installed at the frontal part of the motorcycle, which can direct air in a way that protects the rider from the flow of air while riding. The disclosed fairing has various connection elements with specific material properties in order to be assembled as the front fairing of a motorcycle.

Accordingly, there is a need for a front fairing for a scooter that can be installed and removed with ease.

### PATENT LITERATURE

PTL 1: U.S. patent specification No. 4,010,976

### SUMMARY

One or more embodiments of the present invention provide a scooter with a front fairing disposed on the frontal part of the scooter, where the front faring can be easily installed and maintained and offer protection while the scooter is being operated.

One or more embodiments of the present invention provide a front fairing for a scooter, the scooter having a front fork assembly including a triple tree and a plurality of forks, the front fairing comprising: a fairing body partially defining a shape of the front fairing; the fairing body including a frontward surface and a rearward surface being connected to the front fork assembly; a first connecting member disposed on the rearward surface; at least two second connecting members disposed on the rearward surface, characterized in that the first connecting member provides a temporary connection to the triple tree so that the front fairing is capable of being detached from the triple tree, and the second connecting members provide a temporary connection to the fork so that the front fairing is capable of being detached from the fork, wherein such temporary connection is formed by no more than six fasteners.

According to one or more embodiments, the front fairing does not form a part of any body fairing of the scooter. The front fairing has no part that connects or fixes to the main/overall body of the scooter. Moreover, the front fairing is independently connected to the articulating part of the scooter with a low number of connection points.

As such, the front fairing functions as a separate component from the scooter and can be easily replaced without affecting the other parts of the scooter or the rest of the body fairing. With relatively few connection points, the front fairing may be removed from the scooter with ease. The front fairing can be easily changed by a user at their desire resulting in greater flexibility and customization of the scooter.

Secondly, according to one or more embodiments, the front fairing turns its direction together with the frontal components of the scooter, particularly, a handlebar, a front wheel, and at least one headlight.

As such, the front fairing provides an aesthetic and dynamic property to the scooter, since a conventional scooter would provide a static fairing that is not affected by any turning of direction.

Thirdly, according to one or more embodiments, the front fairing has a sufficient area such that it can function partly as a barrier dividing a rider and the rest of the scooter from the incoming flow of air at the frontal part of the scooter. Moreover, the front fairing directs the flow of air in various directions, as well as prevents any external objects from making contact with the rider or other parts of the scooter.

As such, the front fairing can protect the rider or other parts of the scooter from hazardous objects and/or debris that can present with the incoming flow of air in relative to the direction of the scooter.

In one or more embodiments of the present invention, the fairing body comprises a lower part protruding downwards.

As such, the front fairing has an appearance of a full fairing which provides substantial protection to the rider and aesthetic aspect to the scooter.

In one or more embodiments of the present invention, the front fairing further comprises an opening configured to provide a space for displaying a headlight.

According to one or more embodiments of the present invention, the headlight is positioned at the space provided on the front fairing without necessarily mainly attaching to the front fairing itself.

Therefore, the weight of the headlight does not contribute to the weight of the front fairing, which in turn does not negatively affect the turning and/or steering of the scooter. Moreover, said headlight can also turn its direction with the front fairing. Thus, the headlight will turn into the direction where the scooter is heading, resulting in superior vision for the rider.

In one or more embodiments of the present invention, the front fairing further comprises a rear fairing member engaged with the rearward surface forming an enclosure to provide a space storing one or more component that is essential to the scooter's intended functioning.

According to one or more embodiments of the present invention, since the rear fairing member is engaged with the rearward surface, an enclosure is formed on the rearward surface of the scooter. Therefore, an additional space is provided on the rearward surface. The certain key components of the scooter, such as electrical parts and wirings, can be placed inside the provided space where they are protected and cannot be seen from the outside.

In one or more embodiments of the present invention, the fairing body further comprises a collar, configured to cover a steering apparatus.

According to one or more embodiments of the present invention, support is provided for a steering apparatus, including a handlebar. As such, the handlebar can be placed on the collar, which facilitates the steering of the scooter. Moreover, additional scooter components, such as a dashboard and a windscreen, can be placed on the collar allowing the front fairing to be operated with complete functions.

### BRIEF DESCRIPTION OF THE DRAWINGS

The principles of the present invention and their advantages will become apparent in the following description taking into consideration the accompanying drawings in which:

FIGS. 1A and 1B are perspective views of a front fairing 1, according to one or more embodiments of the present invention;

FIG. 2 is a back view of the front fairing 1, with a front fork assembly 20, according to one or more embodiments of the present invention;

FIGS. 3A and 3B are perspective views of a scooter with the front fairing 1, according to one or more embodiments of the present invention;

FIG. 4 is a back view of the front fairing 1, with a front fork assembly 20, and rear fairing members 40, according to one or more embodiments of the present invention; and

FIG. 5 is an explanation view of the front fairing 1, with a front fork assembly 20, rear fairing members 40, and auxiliary components, according to one or more embodiments of the present invention.

### DETAILED DESCRIPTION

Unless indicated otherwise, certain terminologies are used in the following description for general illustration purposes only and shall not be construed to limit the scope of the concept of the present invention in any way. Likewise, any specific configurations, figures and/or dimensions herein are for illustration purposes and should not be construed to limit the scope of the concept of this technical disclosure.

Unless indicated otherwise, the terminology “scooter” shall be inclusive of any vehicles running on two or more wheels that are characterized by having a step-through frame, irrespective of circumstantial features or specifications, such as power outputs, types of engine, and placement of wheels. Examples of “scooter” under this meaning shall include fuel-driven scooters, electric scooters and so-called hybrid scooters, among others, which may be appreciated by a person having ordinary skills in the relevant technical field.

It must be noted that as used herein and in the appended claims, the singular forms “a”, “an”, and “the” include plural referents unless the context clearly dictates otherwise. Thus, for example, reference to “a component” includes a plurality of components.

In the following detailed description, relative positional terms such as “front”, “rear”, “right”, “left”, “frontward”, and “rearward” correspond to those directions considered from the direction of the displacement of the operating scooter.

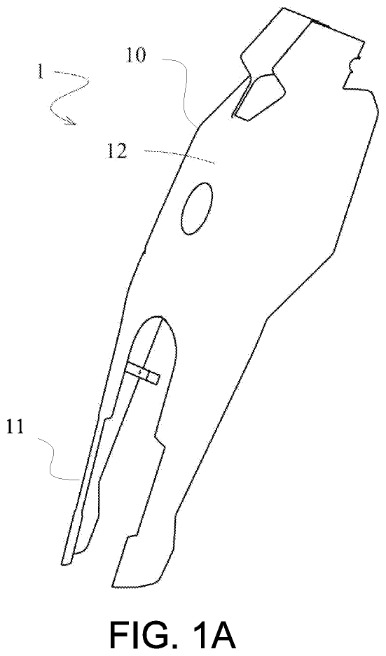

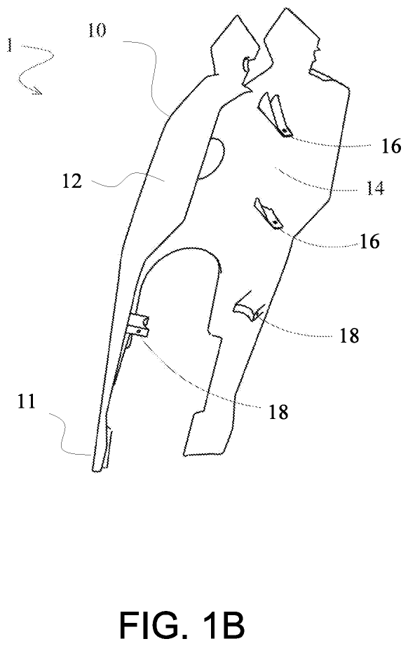

Hereinafter, one or more embodiments of the present invention will be described in detail with reference to FIG. 1A to FIG. 5.

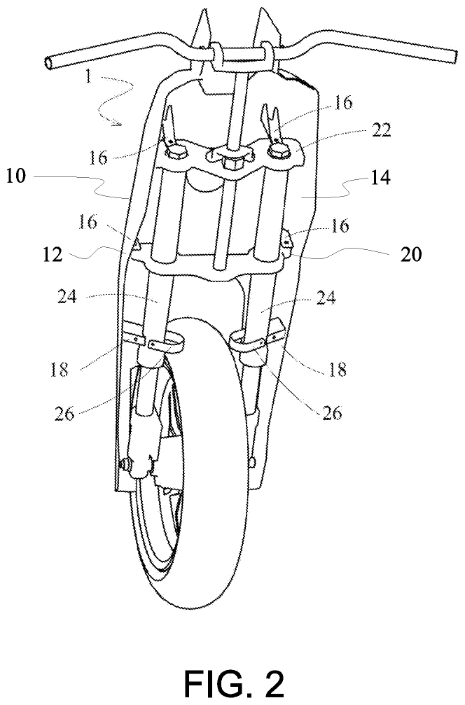

FIGS. 1A and 1B are perspective views of a front fairing 1 for a scooter according to one or more embodiments of the present invention. The front fairing is connected to a front fork assembly of the scooter which will be described in detail hereinafter. As shown in FIGS. 1A and 1B, the front fairing 1 has a fairing body 10, which is the main frame of the front fairing 1. Since the fairing body 10 is the main frame of the front fairing 1, the fairing body 10 defines the majority of the shape of the front fairing 1. Moreover, the fairing body 10 has a frontward surface 12 and a rearward surface 14 being connected to the front fork assembly 20 as shown in FIG. 2. Each of which is configured to facilitate the connection between the front fairing 1 and the scooter. Moreover, the fairing body 10 has a lower part 11 which extends by protruding downwards, providing a full fairing configuration which provides substantial protection to the rider and aesthetic aspects to the scooter.

As shown in FIG. 1B and FIG. 2, the rearward surface 14 is provided with a first connecting member 16. The first connecting member 16 is an extended part protruding from the rearward surface 14 of the fairing body 10. The first connecting member 16 is shaped to connect to the triple tree 22 of the front fork assembly 20. The first connecting member 16 may have a rectangular shape with at least one hole near the outer end. Generally, the first connecting member 16 is shaped integrally with the fairing body 10 within the same mold. More, the rearward surface 14 may be provided with four first connecting members 16, with two at the upper portion and two at the lower portion.

Furthermore, on the rearward surface 14, there is provided at least two second connecting members 18. The second connecting member 18 is an extended part protruding from the lower part of the rearward surface 14 of the fairing body 10. The second connecting member 18 is shaped to receive a fork 24. Generally, the second connecting member 18 is shaped integrally with the fairing body 10 within the same mold. The rearward surface 14 may be provided with two second connecting members 18 on the left side and right side.

FIG. 2 is a back view of the front fairing 1 with a front fork assembly 20, according to one or more embodiments of the present invention. As shown in FIG. 2, the front fork assembly 20 will be discussed in more detail. The scooter is provided with the front fork assembly 20 at the frontal part of the vehicle. The front fork assembly 20 includes two triple trees 22, 22, alternatively called a triple clamp or yoke, located at the upper part and lower part of the assembly, two forks 24 located at the left and right side, and a neck pipe configured to connect between two triple trees 22, 22.

As shown in FIG. 2, the fairing body 10 is provided with four first connecting members 16 and two second connecting members 18, while the front fork assembly 20 includes two triple trees 22 and two forks 24. The first connecting member 16 is connected to the triple tree 22 of the front fork assembly 20. Two of the first connecting members 16 may be connected to the upper triple tree 22 and two of the first connecting members 16 are connected to the lower triple tree 22. The connection may be made by using fasteners, such as a screw penetrating holes provided at the first connecting member 16 and the triple tree 22. The second connecting member 18 is connected to the fork 24. Each second connecting member 18 may be connected to each fork 24. The connection may be made by using fasteners, such as a screw penetrating holes provided at the second connecting member 18 and the fork 24. Moreover, the end of the second connecting member 18 is shaped in a way that it can receive the fork 24. For example, the second connecting member 18 has a curved shape end, specifically, a concave end to receive the cylinder shape of the fork 24. The connection may also include a fork fairing fastener 26 having a straight part and a convex part to receive the second connecting member 18 and the fork 24, respectively.

According to one or more embodiments of the invention, the connection between the front fairing 1 and the front fork assembly 20 has a total of six connection points with four points between the first connecting members 16 and the triple trees 22 and two points between the second connecting members 18 and the forks 24. The connection points as mentioned may be a temporary connection using six fasteners. The front fairing 1 does not form a part of body fairing of the scooter and has no part which connects or fixes to the main/overall body of the scooter. In summary, the front fairing 1 is independently connected to the articulating part of the scooter with six connection points.

As a result, the front fairing 1 can function as a separate component from the scooter and can be easily replaced without affecting the other parts of the scooter or the rest of the body fairing. With only six connection points, the front fairing 1 is interchangeable from the scooter with ease. The front fairing 1 can be easily changed by an end user at their desire providing greater flexibility and customization of the scooter. Additionally, the front fairing 1 has a capability of field removal where a user or a rider can remove the front fairing 1 without help from a technician.

According to one or more embodiments of the invention, the lower part 11 is provided near the wheel of the scooter. The lower part 11 constitutes a full fairing configuration of the front fairing 1.

According to one or more embodiments of the invention, the front fork assembly 20 is connected to a steering apparatus of the scooter, such as a handlebar, at one end of the front fork assembly 20. The front wheel of the scooter is connected to the other end of the front fork assembly 20 at the lower side via two forks 24. With such configuration, the front wheel can turn its direction together with the steering and/or turning of the handlebar.

As a result, with the dynamic movement of the front fairing 1, aesthetic and dynamic properties are provided to the scooter.

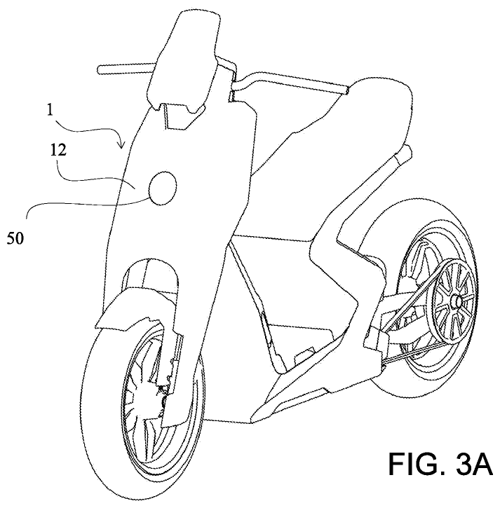

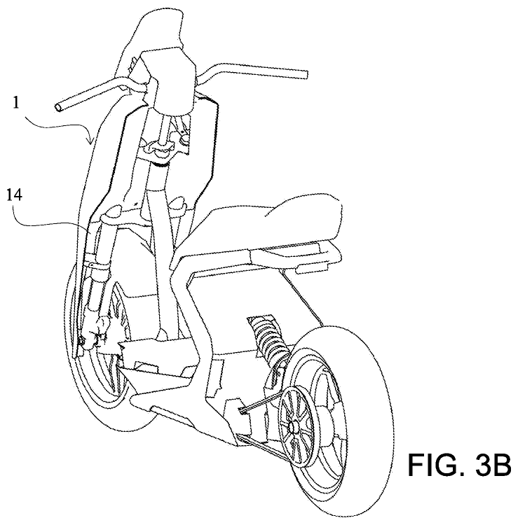

As shown in FIG. 3A, the front fairing 1 connects to the frontal part of the scooter. It is known that the frontal part or frontal frame of any vehicles have an important contribution in the protection of the other parts of the vehicle, as well as in the aerodynamic properties of the vehicle. Accordingly, in one or more embodiments of the present invention, the front fairing 1 can be configured to have a sufficient area, such that it can function as a barrier dividing a rider and the rest of the scooter from the incoming flow of air at the frontal part of the scooter in order to prevent any external objects from making contact with the rider or other parts of the scooter. Moreover, with the sufficient area, the front fairing 1 can also be designed in a way that the front fairing 1 can direct the flow of air in various directions, which facilitate the operation of the scooter.

As a result, the front fairing can protect the rider or other parts of the scooter from hazardous objects and/or debris that can present with the incoming flow of air at high speeds.

As shown in FIGS. 1A and 3A, the front fairing 1 can also include an opening, which goes through the frontward surface 12 and the rearward surface 14. Such opening can be configured to provide a space for displaying a headlight 50 with its frontal direction facing outward from the frontward surface 12. The opening can be merely a cut-out space with the shape of the headlight 50 to simply receive the headlight 50. The opening can provide multiple layers of grooves to provide a snap-fit connection with the headlight 50.

As a result, the headlight 50 can turn its direction with the front fairing 1, as well as the direction where the scooter is heading, resulting in superior vision for the rider.

In one or more embodiments, with the headlight 50 merely received at the opening, the front fairing 1 is not a main support for the headlight 50. The headlight 50 is connected to the lower triple tree 22 of the front fork assembly 20. Thus, the weight of the headlight 50 is supported by the front fork assembly 20.

As a result, the weight of the headlight 50 does not (or negligibly) contribute to the weight of the front fairing 1, which in turn does not negatively affect the turning or steering of the scooter.

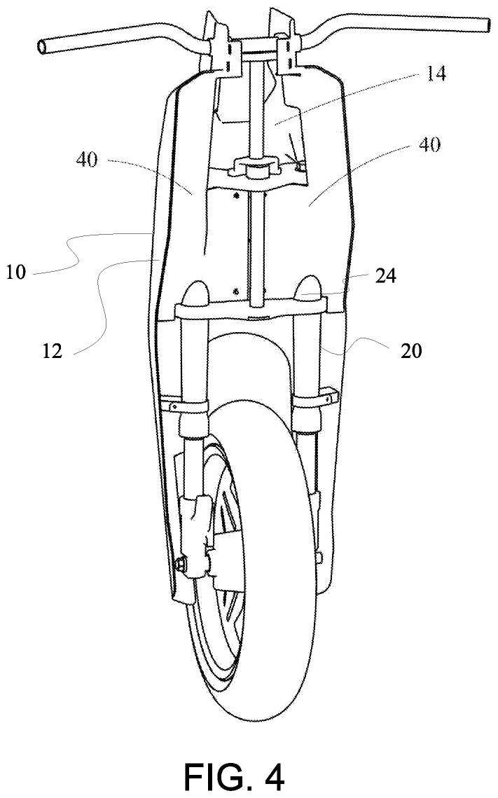

As shown in FIG. 4, the front fairing 1 also has a rear fairing member 40 connected on the rearward surface 14. The rear fairing member 40 is configured to receive the rearward surface 14 of front fairing 1, with multiple protrusions designed to snap-fit with the front fairing 1. The rear fairing member 40 also has at least one hole for connecting the front fairing 1. Therefore, the front fairing 1 can be connected with the rear fairing member 40 with the snap-fit mechanism and by using fasteners. The front fairing 1 may be connected with two rear fairing members 40 at the left side and right side.

As a result, since the rear fairing member 40 is engaged with the rearward surface 14, an enclosure is formed on the rearward surface 14 of the scooter. Therefore, an additional space can be provided on the rearward surface 14 where certain key components of the scooter, such as electrical parts and wirings, can be placed inside. With the closed side of the rear fairing member 40 it can also prevent the inside of the enclosure from being seen.

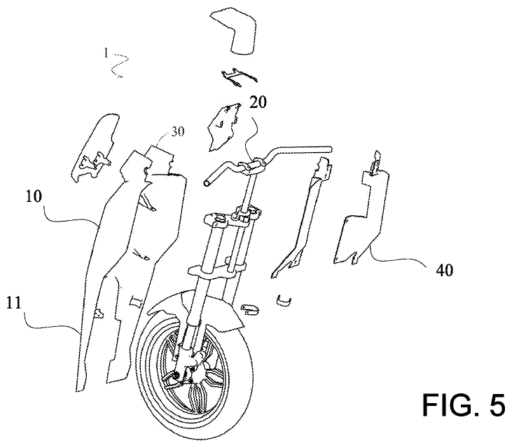

As shown in FIG. 5, the front fairing 1 further has a collar 30, which has two circular parts to cover the handlebar. In addition, auxiliary fairing components can also be connected at the collar 30. The auxiliary fairing components include a fork mask, a dashboard, a dashboard cover, and a windscreen.

As a result, a support is provided for the handlebar. The handlebar can be placed on spaces provided by the collar 30, which facilitates the steering of the scooter. Moreover, additional components can be placed on the collar allowing the front fairing 1 to be operated with complete functions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A front fairing for a scooter that comprises a front fork assembly comprising a triple tree and forks, the front fairing comprising:
a fairing body that partially defines a shape of the front fairing and that comprises:
a frontward surface; and
a rearward surface connected to the front fork assembly;
a first connecting member disposed on the rearward surface and that provides temporary connection to the triple tree such that the front fairing is detachable from the triple tree; and
two or more of second connecting members on the rearward surface each of which provides temporary connection to one of the forks such that the front fairing is detachable from the forks, wherein
the first connecting member and the second connecting members are integral with the fairing body within a same mold,
the rearward surface engages with a rear fairing member,
the rear fairing member and the rearward surface forms an enclosure and provides a space for storing one or more components of the scooter, and
no more than six connection points form temporary connections of the first connecting member and of the second connecting members.

2. The front fairing according to claim 1, wherein the fairing body comprises a lower part protruding downwards.

3. The front fairing according to claim 1, wherein the fairing body further comprises: a collar that covers a steering apparatus of the scooter.

4. The front fairing according to claim 1, further comprising: an opening that receives a headlight.
